(19) United States
(12) Patent Application Publication
(10) Pub. No.: US 2014/0268200 A1
(43) Pub. Date: Sep. 18, 2014

(54) MULTI-FUNCTION PRINTER

(71) Applicant: Kinpo Electronics, Inc., New Taipei City (TW)

(72) Inventor: Sih-Kai Lian, New Taipei City (TW)

(21) Appl. No.: 13/916,589

(22) Filed: Jun. 13, 2013

(30) Foreign Application Priority Data
Mar. 14, 2013 (TW) 102109080

(51) Int. Cl. G06F 3/12; H04N 1/00

(52) U.S. Cl. CPC G06F 3/1221; H04N 1/00278; G06F 3/1229
USPC 358/1.13

(57) ABSTRACT

A multi-function printer (MFP) is provided. The MFP includes a control module, a print module and a pneumatic driving module. The control module is configured to serve as an operation core of the MFP. The print module is controlled by the control module, and configured to perform a print task in response to a print request. The pneumatic driving module is coupled to the control module and the print module, and configured to provide a first pneumatic power serving as the transmission power source of the print module in response to the control of the control module.

### CROSS-REFERENCE TO RELATED APPLICATION

This application claims the priority benefit of Taiwan application serial no. 102109080, filed on Mar. 14, 2013. The entirety of the above-mentioned patent application is hereby incorporated by reference herein and made a part of this specification.

### BACKGROUND OF THE INVENTION

1. Field of the Invention

The invention generally relates to a multi-function printer (MFP), and more particularly, to an MFP capable of effectively reducing/decreasing power consumption.

2. Description of Related Art

With the popularity of the PC, the market for computer peripheral products gets continuous growing, and confronting such situation, the computer peripheral products accordingly and continuously lunch initiatives to meet the various needs of different users. Among the computer peripheral products, the automatic word processing products or image output products feature diversity and popularity in both application and development. For example, many automatic equipments such as scanner, photocopier or printer are everywhere in our daily life for the users to conduct word processing or image output jobs by using the automatic equipments. In nowadays, even an MFP has integrated photocopying, printing and scanning function therein, which largely saves the occupied office space.

However, in term of the current MFP, it mostly use DC motors plus a control mode thereof to serve as its transmission power source and execute multiple functions such as printing/paper-feeding functions. During running such MFP however, the DC motors will produce quite power consumption so that it does not comply with the “energy-saving and carbon reduction” goal pursued by most of the current products.

### SUMMARY OF THE INVENTION

Accordingly, the invention is directed to an MFP, which adopts pneumatic motor(s) serving as the transmission power source required by the function operations in the MFP and further is able to effectively reduce/decrease the whole power consumption of the MFP.

The invention provides an MFP, which includes a control module, a print module and a pneumatic driving module. The control module is configured to serve as an operation core of the MFP. The print module is controlled by the control module, and configured to perform a print task in response to a print request. The pneumatic driving module is coupled to the control module and the print module, and configured to provide a first pneumatic power serving as the transmission power source of the print module in response to the control of the control module.

In an embodiment of the invention, the pneumatic driving module includes at least a pneumatic valve, at least a pneumatic driver and an airflow source. The at least a pneumatic valve is coupled to the control module, and configured to provide an output airflow in response to the control of the control module. The at least a pneumatic drive is coupled to the at least a pneumatic valve, and configured to provide the first pneumatic power in response to the output airflow. The airflow source is coupled to the at least a pneumatic valve, and configured to supply the airflow required by operating the at least a pneumatic valve.

In an embodiment of the invention, the at least one pneumatic valve is implemented with an excitation pneumatic valve.

In an embodiment of the invention, the control module is further configured to provide a first set of control signals to the excitation pneumatic valve so that the first pneumatic power provided, in response to the first set of control signals, by the pneumatic driving module is a forward pneumatic power; and moreover, the control module is further configured to provide a second set of control signals to the excitation pneumatic valve so that the first pneumatic power provided, in response to the second set of control signals, by the pneumatic driving module is a reverse pneumatic power.

In an embodiment of the invention, the excitation pneumatic valve has an elastic structure to buffer the force applied by the excitation pneumatic valve at an excitation instant.

In an embodiment of the invention, the at least a pneumatic driver is implemented with a pneumatic motor.

In an embodiment of the invention, the MFP further includes a user interface (UI) coupled to and controlled by the control module, and the UI is configured to serve as both an input interface and a displaying interface of the MFP.

In an embodiment of the invention, the control module is further coupled to the airflow source to detect whether a residue airflow amount in the airflow source is lower than a predetermined low airflow amount; if the residue airflow amount in the airflow source is lower than a predetermined low airflow amount, the control module generate a warning message.

In an embodiment of the invention, the UI, in response to the warning message, prompts a user corresponding to the multi-function printer to conduct an inflating action on the airflow source.

In an embodiment of the invention, the MFP further includes a voltage source for providing the operation power required by the MFP.

In an embodiment of the invention, the MFP further includes a storage module coupled to and controlled by the control module, where the storage module is configured to serve as a storage medium of the MFP.

In an embodiment of the invention, the MFP further includes a network module coupled to and controlled by the control module, where the network module is configured to make the multi-function printer have a network linking function.

In an embodiment of the invention, the MFP further includes a scan module and a fax module. The scan module is controlled by the control module to perform a scan task in response to a scan request. The fax module is controlled by the control module to perform a fax task in response to a fax request. In this case, the pneumatic driving module is further configured to provide a second pneumatic power and a third pneumatic power respectively serving as the transmission power sources of the scan module and the fax module in response to the control of the control module.

Based on the description above, the invention provides an MFP which adopts pneumatic motor(s) serving as (motive) power source required by each function operation of the MFP, so as to effectively decrease the whole power consumption of the MFP.

In order to make the features and advantages of the present invention more comprehensible, the present invention is further described in detail in the following with reference to the embodiments and the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of an MFP according to an embodiment of the invention.

FIG. 2 is a diagram showing the implementation of a pneumatic driving module in the MFP according to an embodiment of the invention.

FIGS. 3A and 3B are diagrams illustrating a forward airflow/reverse airflow output by the excitation pneumatic valve according to an embodiment of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

FIG. 1 is a schematic block diagram of an MFP 100 according to an embodiment of the invention. Referring to FIG. 1, the MFP 100 includes a control module 110, a pneumatic driving module 120, a print module 130, a scan module 140, a fax module 150, a UI 160, a storage module 170, a network module 180 and a voltage source 190, in which the voltage source 190 is used to provide the MFP 100 with an operation-required power Vop (i.e. the voltage source 190 is configured to provide the operation power Vop required by the MFP 100).

The control module 110 serves as a control core of the MFP 100, i.e., to manage and control the whole operation of the MFP 100. The control module 110, in response to the operation requirement of a user on the MFP 100, controls the MFP 100 to perform corresponding function jobs/tasks. The above-mentioned varied function modules in the MFP 100 in other optional embodiments of the invention can be partially saved or replaced by other function modules depending on the actual design/application requirement.

The pneumatic driving module 120 is coupled between the control module 110 and the print module 130, and configured for providing a pneumatic power serving as the transmission power source of the print module 130 in response to the control of the control module 110, so as to drive the transmission mechanism (not shown) of the print module 130. In this way, the print module 130 controlled by the control module 110 would perform a print task in response to a print request.

FIG. 2 is a diagram showing the implementation of the pneumatic driving module 120 in the MFP 100 according to an embodiment of the invention. Referring to FIGS. 1 and 2, the pneumatic driving module 120 includes a pneumatic valve 122, a pneumatic driver 124 and an airflow source 126. The pneumatic valve 122 is coupled to the control module 110, and configured for providing an output airflow in response to the control of the control module 110. The pneumatic driver 124 is coupled to the pneumatic valve 122, and configured to provide the print module 130 with a pneumatic power in response to the output airflow come from the pneumatic valve 122. The airflow source 126 is coupled to the pneumatic valve 122, and configured for supplying the pneumatic valve 122 with the operation-required airflow. In the embodiment, although the pneumatic driving module 120 has only one pneumatic valve, one pneumatic driver and one pneumatic power shown therein, but in fact, the numbers of the pneumatic valve, the pneumatic driver and the airflow source can be more depending on the actual design/application requirement in the MFP 100. Therefore, the numbers is not limited by FIG. 2.

In the embodiment, the pneumatic valve 122 can provide output airflows in different directions (for example, a forward airflow or a reverse airflow) in response to the control of the control module 110, such that the pneumatic driver 124 can provide a pneumatic power of the corresponding direction (for example, a forward airflow power or a reverse airflow power) in response to the output airflows with different directions provided by the pneumatic valve 122. It should be noted that in the embodiment, the adopted pneumatic valve 122 is an excitation pneumatic valve which can provide output airflows with different directions according to different sets of control signals provided by the control module 110. In other words, the control module 110 can provide a first set of control signals composed of digital control signals to the excitation pneumatic valve (i.e., 122), so that the pneumatic power provided, in response to the first set of control signals, by the pneumatic driving module 120 can be a forward pneumatic power; on contrary, the control module 110 can provide a second set of control signals composed of digital control signals to the excitation pneumatic valve (i.e., 122), so that the pneumatic power provided, in response to the second set of control signals, by the pneumatic driving module 120 can be a reverse pneumatic power.

Referring to FIGS. 3A and 3B for better understanding, FIGS. 3A and 3B are diagrams illustrating a forward airflow/reverse airflow output by the excitation pneumatic valve according to an embodiment of the invention. A first side 122_1 and a second side 122_2 of the excitation pneumatic valve (i.e., 122) are respectively used to receive different sets of control signals (for example but not limited to, digital control signals of “000”, “111”, and so on) sent by the control module 110, in which the digital control signals can be output through general-purpose input/output ports (GPIO ports) of the control module 110. If the excitation pneumatic valve (i.e., 122) receives different digital control signals at the both sides thereof, the excitation pneumatic valve (i.e., 122) would provide output airflows in/with different directions.

Taking an example, if the first side 122_1 of the excitation pneumatic valve (i.e., 122) receives the digital control signals of “111” sent by the control module 110 and the second side 122_2 receives the digital control signals of “000”, it represents that the excitation pneumatic valve (i.e., 122) would output a forward airflow as shown by FIG. 3A, the pneumatic driver 124 thereby can provide a forward pneumatic power; on contrary, if the first side 122_1 of the excitation pneumatic valve (i.e., 122) receives the digital control signals of “000” and the second side 122_2 receives the digital control signals of “111”, it represents that the excitation pneumatic valve (i.e., 122) would output a reverse airflow as shown by FIG. 3B, the pneumatic driver 124 thereby can provide a reverse pneumatic power. In this way, since the excitation pneumatic valve (i.e., 122) can provide both the forward airflow and the reverse airflow, the pneumatic driver 124 can accordingly provide the forward pneumatic power and the reverse pneumatic power.

On the other hand, the excitation pneumatic valve (i.e., 122) may include an elastic structure 310 therein serving as a buffer unit in the excitation pneumatic valve (i.e., 122), which contributes to buffer the force applied by the pneumatic valve 122 at excitation instant and avoids the discord pneumatic power outputs caused by the collision of forces of the excitation pneumatic valve (i.e., 122) during the magnetic triggering course. In the embodiment, the elastic structure 310 is implemented by a spring, which the invention is not limited thereto.

Referring to FIG. 2, the pneumatic driver 124 in the embodiment is a pneumatic motor, which can provide a forward pneumatic power or a reverse pneumatic power in response to the forward airflow or the reverse airflow provided by the pneumatic valve 122. In more details, the pneumatic motor (i.e., 124) is a (motive) power device utilizing the output airflow provided by the pneumatic valve 122 to produce an internal pressure energy, followed by converting the internal pressure energy into a rotational mechanic energy. The rotation direction of the pneumatic motor (i.e., 124) is generally the same as the direction of the output airflow provided by the pneumatic valve 122.

Taking the print module 130 of the MFP 100 as an example (as shown by FIG. 1), in general the print module 130 has a paper-feeding motor therein (not shown) serving as the (motive) power source to feed paper and a carriage motor (not shown) serving as the (motive) power source for left-shifting printing/right-shifting printing, so as to drive the transmission mechanism in the print module 130 (for example but not limited to, composed of un-shown transmission gears/rollers and transmission shafts) and perform the forwarding paper/reversing paper function and the left-shifting printing/right-shifting printing function. Moreover, the control module 110 can control the total amount of the output airflow of the excitation pneumatic valve (i.e., 122), by which the amplitude of the pneumatic power provided by the pneumatic motor (i.e., 124) can be controlled to achieve constant or slowing printing goal. Since the pneumatic motor (i.e., 124) in the embodiment can provide a forward pneumatic power and a reverse pneumatic power for operation, each of the paper-feeding motor and the carriage motor in the print module 130 can be implemented with the pneumatic motor (i.e., 124). It can be seen the embodiment adopts the pneumatic motor (i.e., 124) to serve as the printing-required transmission power source in the MFP 100, not the DC motor in the prior art, the invention can effectively decrease the whole power consumption of the MFP 100.

On the other hand, the UI 160 of the MFP 100 is coupled to and controlled by the control module 110 and serves as both the input interface and the displaying interface of the MFP 100. In the embodiment, the UI 160 can be a touch screen of any type such as resistive touch screen, capacitive touch screen, optical touch screen, acoustic wave touch screen, electromagnetic touch screen and so on, which the invention is not limited thereto.

It should be noted that, as shown by FIG. 2, since the control module 110 can further be coupled to the airflow source (i.e., 126) in the pneumatic driving module 120, the control module 110 can be further used to detect/sense whether a residue airflow amount in the airflow source (i.e., 126) is lower than a predetermined low airflow amount; if the residue airflow amount in the airflow source is lower than the predetermined low airflow amount, the control module 110 generates a warning message to govern/control the UI 160 to prompt the user for conducting inflating action on the airflow source (i.e., 126) in the pneumatic driving module 120 through text or picture on the UI 160. In other words, the UI 160 would, in response to the warning message generated by the control module 110, prompt the user corresponding to the MFP 100 to conduct an inflating action on the airflow source (i.e., 126). In the embodiment, the user can to conduct an inflating action on the airflow source (i.e., 126) in the pneumatic driving module 120 through different methods/manners, for example, the user can use a manual or a foot pumping device to conduct inflating action on the airflow source (i.e., 126), which the invention is not limited thereto.

On the other hand, the MFP 100 can perform communication with the local computer 20 within a local area network (LAN) through the network module 180; even the MFP 100 can communicate with all the remote computers 40 on the Internet 30 through the network module 180. Obviously, at the time, the MFP 100 can, through the network module 180, serve as a network printer for the local computer 20 and all the remote computers 40. In the embodiment, the network module 180 can be any type of wired or wireless network module so that the MFP 100 has LAN/WAN connection function.

In addition, the storage module 170 can serve as a storage medium of the MFP 100. In the embodiment, the storage module 170 can be any type of non-volatile memory, for example, flash memory, EEPROM, hard-disc drive (HDD) and so on, which the invention is not limited thereto.

In addition, the scan module 140 is controlled by the control module 110, and performs a scan task in response to a scan request. The fax module 150 is controlled by the control module 110, and performs a fax task in response to a fax request. It should be noted that the pneumatic driving module 120 can further be coupled between the scan module 140, the fax module 150 and the control module 110, and at the time, the pneumatic driving module 120 can provide the corresponding pneumatic power(s) serving as the transmission power source(s) of the scan module 140 and/or the fax module 150 in response to the control of the control module 110. Accordingly, the numbers of the pneumatic valve (122), the pneumatic driver (124) and the airflow source (126) in the pneumatic driving module 120 are respectively three, in which however the three airflow sources (126) may be shared to one only. That is, the pneumatic driving module 120 in the embodiment can provide a pneumatic power to drive the transmission mechanisms (for example but not limited to, composed of transmission gears/rollers and transmission shafts) in the scan module 140 and/or the fax module 150 under the control of the control module 110 so as to perform scanning and/or faxing operation or task.

In summary, the MFP 100 provided by the invention can use the pneumatic driving module 120 as the transmission power sources of the print module 130, the scan module 140 and the fax module 150 of the MFP 100 under the control of the control module 110. In addition, since the pneumatic driving module 120 can provide the forward pneumatic power or the reverse pneumatic power to the print module 130, the scan module 140 and the fax module 150 in response to the control of the control module 110, therefore, the MFP 100 can perform corresponding tasks depending on the various operation requirements of the user, so as to effectively decrease the whole power consumption of the MFP 100.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A multi-function printer, comprising:
a control module, configured to serve as an operation core of the multi-function printer;
a print module, controlled by the control module, and configured to perform a print task in response to a print request; and
a pneumatic driving module, coupled between the control module and the print module, and configured to provide a first pneumatic power serving as transmission power source of the print module in response to the control of the control module.

2. The multi-function printer as claimed in claim 1, wherein the pneumatic driving module comprises:
at least a pneumatic valve, coupled to the control module, and configured to provide an output airflow in response to control of the control module;
at least a pneumatic driver, coupled to the at least a pneumatic valve, and configured to provide the first pneumatic power in response to the output airflow; and
an airflow source, coupled to the at least a pneumatic valve, and configured to supply an airflow required by operating the at least a pneumatic valve.

3. The multi-function printer as claimed in claim 2, wherein the at least a pneumatic valve is implemented with an excitation pneumatic valve.

4. The multi-function printer as claimed in claim 3, wherein:
the control module is further configured to provide a first set of control signals to the excitation pneumatic valve so that the first pneumatic power provided, in response to the first set of control signals, by the pneumatic driving module is a forward pneumatic power; and
the control module is further configured to provide a second set of control signals to the excitation pneumatic valve so that the first pneumatic power provided, in response to the second set of control signal, by the pneumatic driving module is a reverse pneumatic power.

5. The multi-function printer as claimed in claim 3, wherein the excitation pneumatic valve has an elastic structure to buffer force applied by the excitation pneumatic valve at an excitation instant.

6. The multi-function printer as claimed in claim 2, wherein the at least a pneumatic driver is implemented with a pneumatic motor.

7. The multi-function printer as claimed in claim 2, further comprising:
a user interface, coupled to and controlled by the control module, and configured to serve as both an input interface and a displaying interface of the multi-function printer.

8. The multi-function printer as claimed in claim 7, wherein the control module is further coupled to the airflow source to detect whether a residue airflow amount in the airflow source is lower than a predetermined low airflow amount; and if the residue airflow amount in the airflow source is lower than the predetermined low airflow amount, than the control module generates a warning message.

9. The multi-function printer as claimed in claim 8, wherein the user interface, in response to the warning message, prompts a user corresponding to the multi-function printer to conduct an inflating action on the airflow source.

10. The multi-function printer as claimed in claim 1, further comprising:
a voltage source, configured to provide an operation power required by the multi-function printer.

11. The multi-function printer as claimed in claim 1, further comprising:
a storage module, coupled to and controlled by the control module, and configured to serve as a storage medium of the multi-function printer.

12. The multi-function printer as claimed in claim 1, further comprising:
a network module, coupled to and controlled by the control module, and configured to make the multi-function printer have a network connection function.

13. The multi-function printer as claimed in claim 1, further comprising:
a scan module, controlled by the control module, and configured to perform a scan task in response to a scan request; and
a fax module, controlled by the control module, and configured to perform a fax task in response to a fax request,
wherein the pneumatic driving module is further configured to provide a second pneumatic power and a third pneumatic power respectively serving as the transmission power sources of the scan module and the fax module in response to the control of the control module.
